(19) United States
(12) Patent Application Publication
(10) Pub. No.: US 2012/0013556 A1
(43) Pub. Date: Jan. 19, 2012

(54) GESTURE DETECTING METHOD BASED ON PROXIMITY-SENSING

(75) Inventors: Yi-Ta Chen, Taoyuan County (TW); Min-Feng Yen, Taoyuan County (TW)

(73) Assignee: Edamak Corporation, Taoyuan County (TW)

(21) Appl. No.: 13/183,614

(22) Filed: Jul. 15, 2011

(30) Foreign Application Priority Data
Jul. 16, 2010 (TW) 099123502

(51) Int. Cl. G06F 3/041

(52) U.S. Cl. 345/173; 178/18.03

(57) ABSTRACT

A gesture detecting method based on proximity sensing is provided when an object is approaching close to a proximity-sensing panel. The moving direction of the object is detected to generate multiple sensing values. The sensing values are able to define one or more moving tendencies corresponding to sensing axes on the proximity-sensing panel. The moving tendencies corresponding to all sensing axes are able to define one or more moving traces, and the moving traces are able to define one or more gesture. On the other hand, the quantity of the sensing value(s) and the moving tendency(s) are able to define the moving trace(s); then the gesture(s) is able to be further defined.

### CROSS-REFERENCES TO RELATED APPLICATIONS

This non-provisional application claims priority under 35 U.S.C. §119(a) on Patent Application No. 99123502 filed in Taiwan, R.O.C. on 2010/7/16, the entire contents of which are hereby incorporated by reference.

### BACKGROUND

1. Technical Field

The present invention relates to a proximity-sensing panel and in particular to a gesture detecting method based on proximity sensing.

2. Related Art

Accompanying with developments of optoelectronics technology, proximity switching device has been massively applied to various machines, e.g. smart phone, transportation ticketing system, digital camera, remote control, liquid crystal display (LCD) and etc. A common proximity switching device includes a proximity sensor and a touch panel.

Generally a touch panel includes resistive type, Surface Capacitive type, Projected Capacitive type, infrared type, sound wave type, optical type, magnetic sensing type, digital type and etc. “iPhone” is one of the most famous smart phone product among various touch-control application products, in which a Projective Capacitive Touch (PCT) panel is applied. In its panel structure, multiple single-layer X-axis electrodes and multiple single-layer Y-axis electrodes are used to form cross-aligned electrode structures. By scanning of X-axis and Y-axis electrodes, touch operations of an object are able to be detected. Therefore, PCT panel is able to achieve the technical requirements of multi-touch operations that perform many actions a single-touch operation cannot achieve.

Proximity sensor is also known as proximity switch, which is applied to various applications including liquid crystal display televisions, power source switches, power switches of home appliances, door security systems, remote controllers, mobile phones and etc. In the recently years, proximity sensor becomes more irreplaceable. Proximity sensor detects if an object is approaching, such that the controller is acknowledges with the current position of the object. Taking home appliance as an example, proximity sensors are used on the liquid crystal display of light resources; as long as a user's hand approaches close to the liquid crystal display, the liquid crystal display will turn on or off the light resource according to the detected sensing signals. Please refer to FIG. 1, which is a functional block diagram of a conventional proximity sensing system. Proximity sensing system 2 includes a proximity-sensing unit 4, sensing circuit 5 and microcontroller 6. When object 3 approaches close to proximity-sensing unit 4, the capacitance sensed by proximity-sensing unit 4 varies according to the distance of object 3. Sensing circuit 5 outputs a control signal according to the capacitance sensed by proximity-sensing unit 4, and transmits to microcontroller 6 or a controlled loading terminal.

Nowadays various display panels are greatly applied to different devices. The conventional resistive-type and capacitive-type touch panels must have the user's hand actually touch and contact the panels to detect the changes by their sensing modules and define a gesture. If a method of detecting a gesture on a proximity-sensing panel is able to be researched, the interactivities between the user and the panel will be majorly increased.

### SUMMARY

Accordingly, in an embodiment of the disclosure, a gesture detecting method is provided. The gesture detecting method is applied to a proximity-sensing panel with multiple sensing axes disposed at a perimeter of the proximity-sensing panel, each of the sensing axes having multiple proximity-sensing units. The method includes the following portions. Through each of the proximity-sensing units of the sensing axes, detect the movement of one or more object and generating multiple initial sensing values respectively. Calculate one or more initial coordinate according to the initial sensing values detected through each of the sensing axes. Detect sequently the movement of the object and generating multiple sequent sensing values. Calculate one or more sequent coordinate according to the sequent sensing values detected through the sensing axes. Define one or more moving tendency on each of the sensing axes according to the initial coordinate and the sequent coordinate detected through the sensing axes. Define a gesture during a preset time according to the moving tendencies of the sensing axes.

In another embodiment, another gesture detecting method is provided. The gesture detecting method is applied to a proximity-sensing panel with multiple sensing axes disposed at a perimeter of the proximity-sensing panel, each of the sensing axes having multiple proximity-sensing units. The method includes the following portions. Through each of the proximity-sensing units of the sensing axes, detect the movement of one or more object and generating multiple initial sensing values respectively. Calculate one or more initial coordinate according to the initial sensing values detected through each of the sensing axes. Detect sequently the movement of the object and generating multiple sequent sensing values. Calculate one or more sequent coordinate according to the sequent sensing values detected through the sensing axes. Define one or more moving tendency on each of the sensing axes according to the initial coordinate and the sequent coordinate detected through the sensing axes. Define a gesture during a preset time according to the moving tendencies of the sensing axes, the initial sensing values and the sequent sensing values of the proximity-sensing units.

### BRIEF DESCRIPTION OF THE DRAWINGS

The disclosure will become more fully understood from the detailed description given herein below for illustration only, and thus are not limitative of the disclosure, and wherein:

FIG. 1 is a functional block diagram of a conventional proximity sensing system;

FIG. 2A is an explanatory diagram of a proximity-sensing panel with four sensing axes according to an embodiment of the disclosure;

FIG. 2B is an explanatory coordinate diagram of a sensing axis of a proximity-sensing panel according to another embodiment;

FIG. 2C is an explanatory coordinate diagram of another sensing axis of a proximity-sensing panel according to another embodiment;

FIG. 2D is an explanatory coordinate diagram of another sensing axis of a proximity-sensing panel according to another embodiment;

FIG. 2E is an explanatory diagram of another proximity-sensing panel with moving direction tendencies according to another embodiment;

FIG. 3A is an explanatory diagram of another proximity-sensing panel detecting moving direction tendencies and a common gesture according to another embodiment;

FIG. 3B is an explanatory diagram of another proximity-sensing panel detecting moving direction tendencies and another common gesture according to another embodiment;

FIG. 3C is an explanatory diagram of another proximity-sensing panel detecting moving direction tendencies and another common gesture according to another embodiment;

FIG. 3D is an explanatory diagram of another proximity-sensing panel detecting moving direction tendencies and another common gesture according to another embodiment;

FIG. 3E is an explanatory diagram of another proximity-sensing panel detecting moving direction tendencies and another common gesture according to another embodiment;

FIG. 3F is an explanatory diagram of another proximity-sensing panel detecting moving direction tendencies and another common gesture according to another embodiment;

FIG. 3G is an explanatory diagram of another proximity-sensing panel detecting moving direction tendencies and another common gesture according to another embodiment;

FIG. 3H is an explanatory diagram of another proximity-sensing panel detecting moving direction tendencies and another common gesture according to another embodiment;

FIG. 4A is an explanatory diagram of another proximity-sensing panel detecting moving direction tendencies and a rotation gesture according to another embodiment;

FIG. 4B is an explanatory diagram of another proximity-sensing panel detecting moving direction tendencies and another rotation gesture according to another embodiment;

FIG. 5A is an explanatory diagram of another proximity-sensing panel detecting moving direction tendencies and a special gesture according to another embodiment;

FIG. 5B is an explanatory diagram of another proximity-sensing panel with moving direction tendencies and another special gesture according to another embodiment;

FIG. 5C is an explanatory diagram of another proximity-sensing panel with moving direction tendencies and another special gesture according to another embodiment;

FIG. 6A is an explanatory diagram of another proximity-sensing panel with moving direction tendencies and another gesture according to another embodiment;

FIG. 6B is an explanatory coordinate diagram of a sensing axis of a proximity-sensing panel according to another embodiment;

FIG. 6C is an explanatory diagram of another proximity-sensing panel with moving direction tendencies and another gesture according to another embodiment;

FIG. 6D is an explanatory coordinate diagram of another sensing axis of a proximity-sensing panel according to another embodiment;

FIG. 7 is an explanatory diagram of another proximity-sensing panel with sensing axes and moving direction tendencies according to another embodiment;

FIG. 8 is a flow chart of a gesture detecting method applied on a proximity-sensing panel according to an embodiment; and

FIG. 9 is a flow chart of a gesture detecting method applied on a proximity-sensing panel according to another embodiment.

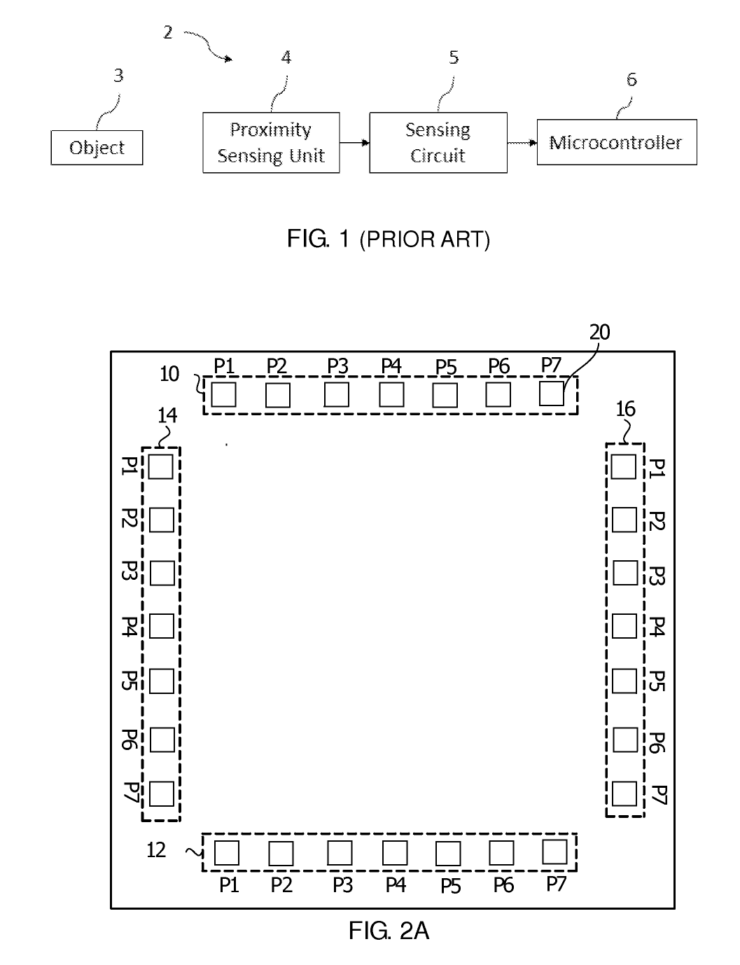

### DETAILED DESCRIPTION

Described in the disclosed embodiments are mainly related to the follows. When an object is approaching close to a proximity-sensing panel, multiple proximity-sensing units generate multiple sensing values. Moving tendencies of the object are defined according to the sensing values, so that the moving tendencies are able to be used as a basis to define a gesture detected by a proximity-sensing panel. Namely, when a user would like to initiate a gesture-detecting mode or use an object to control the proximity-sensing panel, the following embodiments are able to be used for controlling the proximity-sensing panel and obtaining predetermined gesture commands. The gesture detecting method is applied to a proximity-sensing panel with multiple sensing axes disposed thereon. These sensing axes are formed at a perimeter of the proximity-sensing panel. Each of the sensing axes has multiple proximity-sensing units respectively. For example, a sensing axis is formed at each of four sides of the proximity-sensing panel, or a sensing axis is formed at each of the two adjacent sides of the proximity-sensing panel.

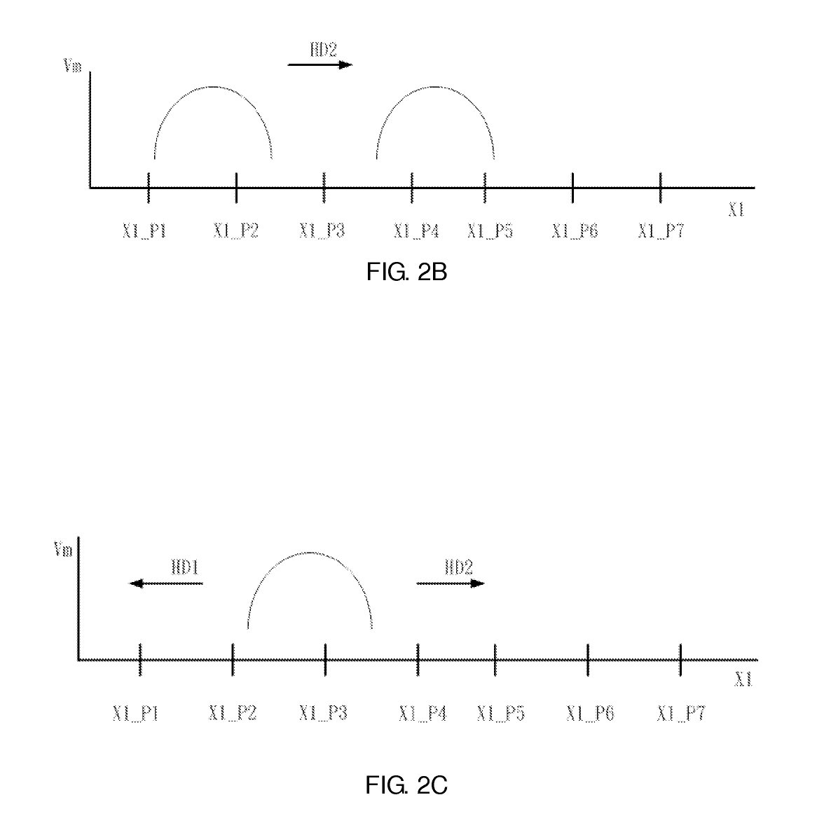

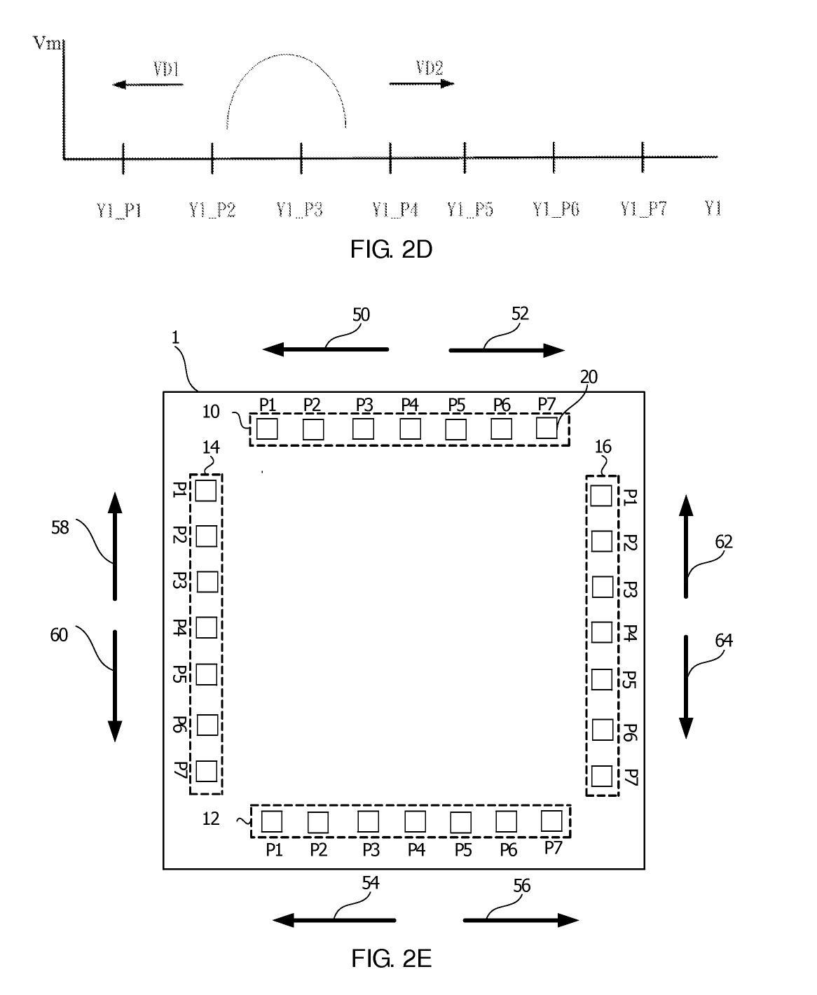

Please refer to FIG. 2A, which is an explanatory diagram of a proximity-sensing panel with four sensing axes according to an embodiment of the disclosure. The four sensing axes are defined as X1 axis 10, X2 axis 12, Y1 axis 14 [symbol] Y2 axis 16, axes in four different directions. Each of the sensing axes includes 7 proximity-sensing units 20. On X1 axis 10 of FIG. 2A, the proximity-sensing units 20 includes X1_P1, X1_P2, X1_P3, X1_P4, X1_P5, X1_P6 and X1_P7. On X2 axis 12, the proximity-sensing units 20 are X2_P1, X2_P2, X2_P3, X2_P4, X2_P5, X2_P6 and X2_P7. On Y1 axis 14, the proximity-sensing units 20 are Y1_P1, Y1_P2, Y1_P3, Y1_P4, Y1_P5, Y1_P6 and Y1_P7. On Y2 axis 16, the proximity-sensing units 20 are Y2_P1, Y2_P2, Y2_P3, Y2_P4, Y2_P5, Y2_P6 and Y2_P7. P1 point on X1 axis 10 is called as X1_P1 coordinate; P5 point on X1 axis 10 is called as X1_P5 coordinate. P1 point on Y1 axis 14 is called as Y1_P1 coordinate; P5 point on Y1 axis 14 is called as Y1_P5 coordinate. The sensing axes in the disclosure are able to be applied with two ones, three ones or more; as well as sensing units 20. The following embodiments use four sensing axes to explain the gesture detecting method based on proximity sensing.

The disclosed gesture detecting method is to detect the moving traces sensed through the sensing axes and the sensing values of the proximity-sensing units 20. When an object moves, proximity-sensing units 20 of the four axes X1 axis 10, X2 axis 12, Y1 axis 14 and Y2 axis 16 senses the changes of sensing values; according to the changes of the sensing values, two sets of parameter information, moving tendencies and sensing values, are able to be defined.

Please refer to FIG. 2B, which is an explanatory coordinate diagram of a sensing axis according to another embodiment. When an object moves to sensing axis X1 axis 10, during a preset time, moving from X1_P1 to X1_P5, the passed points are X1_P1, X1_P2, X1_P3, X1_P4 are X1_P5, with corresponding sensing values X1_P1(Vm), X1_P2(Vm), X1_P3(Vm), X1_P4(Vm) and X1_P5(Vm) respectively. By using two coordinates such as X1_P1(Vm) and X1_P2(Vm), or X1_P1(Vm) and X1_P5(Vm), a moving tendency of the object on sensing axis X1 axis 10 is able to be calculated; in which X1_P1 may be defined as an initial coordinate, while X1_P5 may be defined as a sequent coordinate. The moving tendency in the embodiments may be selected from the group consisting of horizontal moving tendency, vertical moving tendency and any combination thereof. Next, refer to FIG. 2C, X1 axis 10 is taken as an example for the horizontal moving tendency. Horizontal moving tendency in an embodiment includes: positive direction tendency HD1 and negative direction tendency HD2. Here positive direction tendency HD1 is able to be defined as a tendency moving from X1_P1 to X1_P5. The reverse direction tendency HD2 is able to be defined as another tendency moving from X1_P5 to X1_P1. In fact, the movement of an object is namely the movement of the wave in the drawings. The gesture detecting method disclosed in the embodiments of the disclosure defines an object's moving trace(s) according to the moving tendencies and the sensing values. Please refer to FIG. 2D, the vertical moving tendency on Y1 axis 14 is now taken as an example. The vertical moving tendency includes: upward direction tendency VD1 and downward direction tendency VD2. In an embodiment, upward direction tendency VD2 is able to be defined as a tendency moving from Y1_P5 to Y1_P1; in another embodiment, downward direction tendency VD1 is able to be defined as a tendency moving from Y1_P1 to Y1_P5.

Please refer to FIG. 2E, which is an explanatory diagram of another proximity-sensing panel with moving direction tendencies according to another embodiment. Eight directions are defined in the present embodiment, including X1 positive direction tendency 52, X1 negative direction tendency 50, X2 positive direction tendency 56, X2 negative direction tendency 54, Y1 downward direction tendency 60, Y1 upward direction tendency 58, Y2 downward direction tendency 64 and Y2 upward direction tendency 62.

On X1 axis 10, two directions X1 positive direction tendency 52 and X1 negative direction tendency 50 are defined. X1 positive direction tendency 52 indicates the moving direction on X1 axis 10 from X1_P1 to X1_P5; on the contrary, X1 negative direction tendency 50 is the moving direction on X1 axis 10 from X1_P5 to X1_P1.

On X2 axis 12, two directions X2 positive direction tendency 56 and X2 negative direction tendency 54 are defined. X2 positive direction tendency 56 indicates the moving direction on X2 axis 12 from X2_P1 to X2_P5; on the other hand, X2 negative direction tendency 54 indicates the moving direction on X2 axis 12 from X2_P5 to X2_P1.

On Y1 axis 14, two directions Y1 downward direction tendency 60 and Y1 upward direction tendency 58 are defined. Y1 downward direction tendency 60 indicates the moving direction on Y1 axis 14 from Y1_P1 to Y1_P5; on the contrary, Y1 upward direction tendency 58 indicates the moving direction on Y1 axis 14 from Y1_P5 to Y1_P1.

On Y2 axis 16, two directions are defined: Y2 downward direction tendency 64 and Y2 upward direction tendency 62. Y2 downward direction tendency 64 indicates the moving directions on Y2 axis 16 from Y2_P1 to Y2_P5; on the other hand, Y2 upward direction tendency 62 indicates the moving direction on Y2 axis 16 from Y2_P5 to Y2_P1.

As long as the proximity-sensing panel enters into the gesture detection mode, the sensing values of proximity-sensing units 20 and the moving tendencies indicating the eight directions are used as basis to define the detected gesture. The object's movement, i.e. the finger's movement, actually includes the changes of moving directions; therefore the results combined within a moving trace, are also the combination of the movements of single finger or multiple fingers. Namely, the detected coordinate in the end is the combination result of single finger or multiple fingers. Hence under the gesture detecting mode, the moving tendency and the sensing values are first used to define the moving trace of the object/finger, and then the gesture is able to be defined according to the.

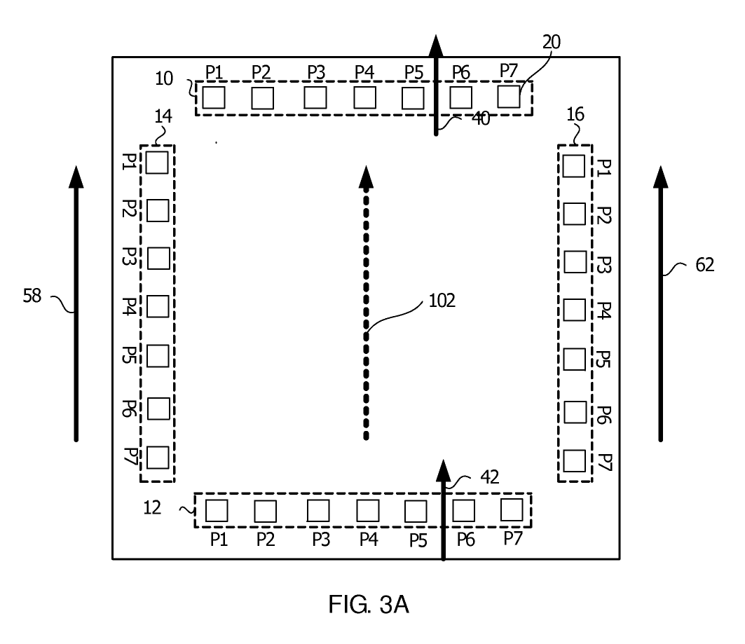

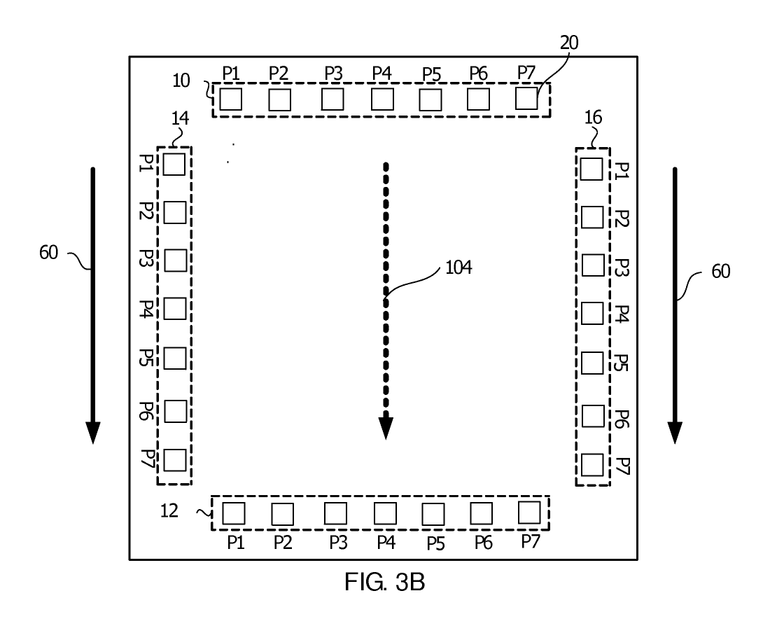

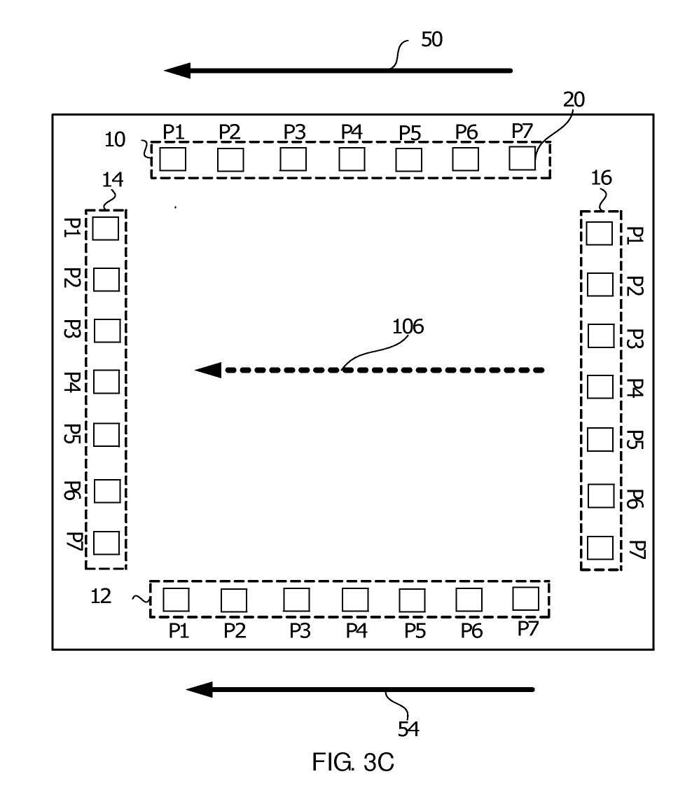

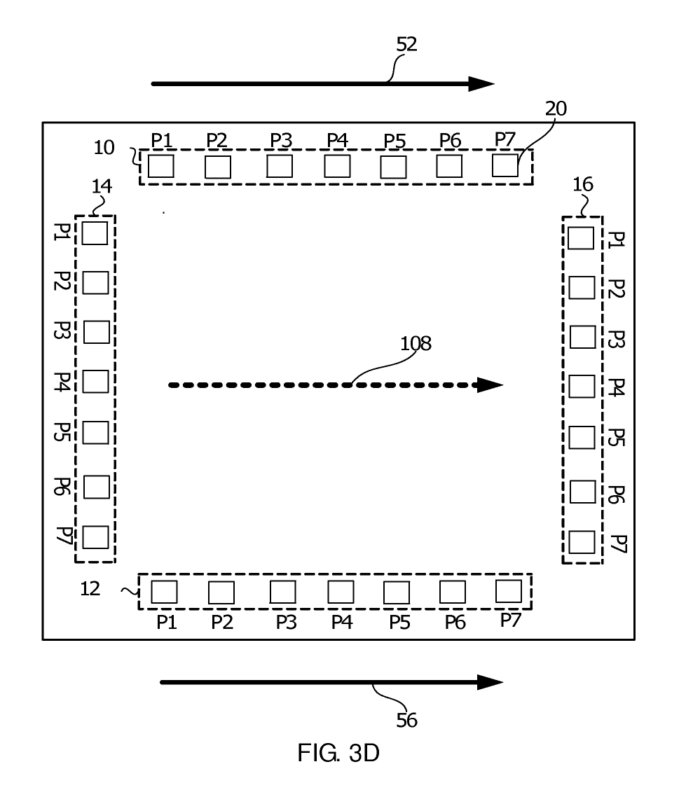

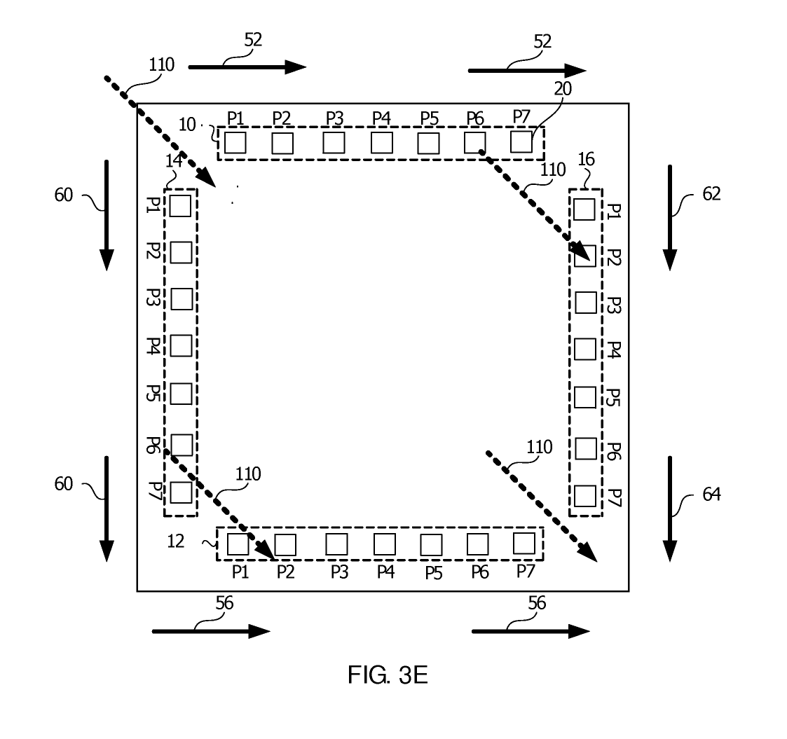

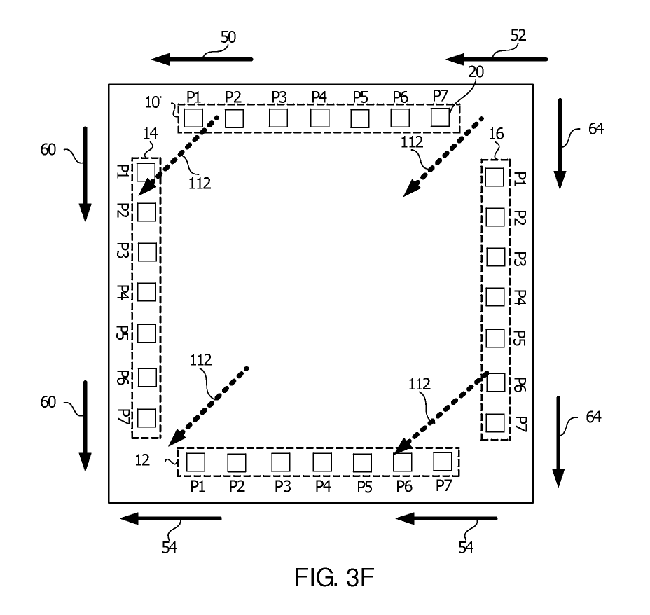

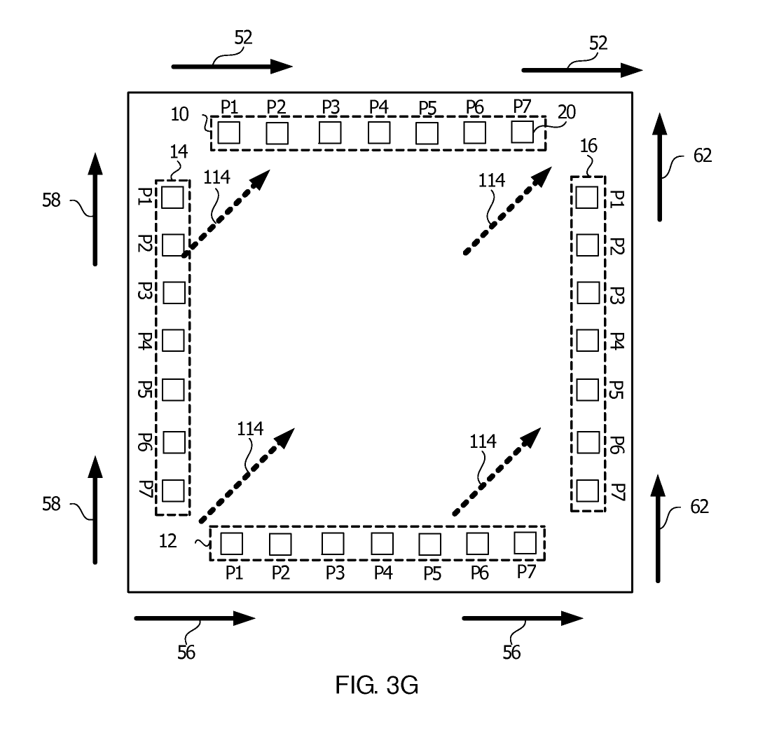

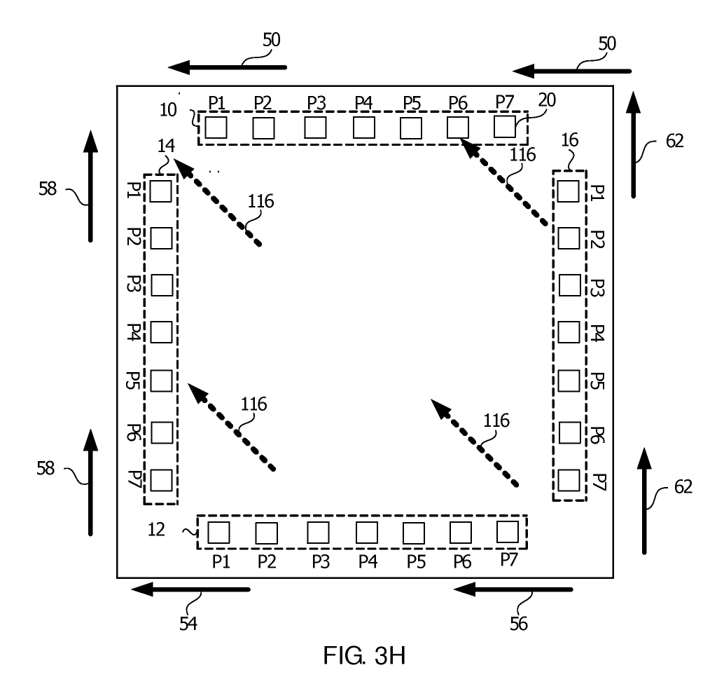

In FIG. 3A-FIG. 3H, several types of moving traces are introduced. FIG. 3A shows an upward trace; FIG. 3B shows a downward trace; FIG. 3C shows a leftward trace; FIG. 3D shows a rightward trace; FIG. 3E shows a right downward trace; FIG. 3F shows a left downward trace; FIG. 3G shows a right upward trace; and FIG. 3H shows a left upward trace. The moving trace(s) of any object is able to be defined by being completed within a preset time; in an embodiment, a general preset time is set as 0.1˜3 seconds.

In another embodiment, the conditions to complete a moving trace are listed as follows.

### Example 1

Refer to FIG. 3A. To complete an upward trace 102, one or more of conditions S1, S2 and S3 need to be fulfilled:

S1: Generate Y1 upward direction tendency 58 on Y1 axis 14.

S2: Generate Y2 upward direction tendency 62 on Y2 axis 16.

S3: Firstly the proximity-sensing units of X2 axis 12 detect to obtain sensing values, and one or more of the sensing values exceeds a preset threshold; plus the proximity-sensing units of X1 axis 10 detect sensing values with the sensing values exceeding the preset threshold. Thus, it is confirmed that the object moves from X2 axis 12 to X1 axis 10.

If either condition S1 or S2 or S3 is generated, an upward trace 102 is defined.

If both conditions S1 and S2 are generated, upward trace 102 is defined.

If both conditions S1 and S3 are generated, upward trace 102 is defined.

### Example 2

Refer to FIG. 3B; to define a downward trace 104, one or more conditions S1, S2 and S3 need to be fulfilled:

S1: Generate Y1 downward direction tendency 60 on Y1 axis 14.

S2: Generate Y2 downward direction tendency 64 on Y2 axis 16.

S3: Firstly proximity-sensing units of X1 axis 10 detect to obtain certain sensing values exceeding a preset threshold, and then proximity-sensing units of X2 axis 12 detect the sensing values exceeding the preset threshold as well. Thus, it is confirmed that the object moves from X1 axis 10 to X2 axis 12.

If either condition S1 or S2 or S3 is generated, downward trace 104 is defined.

If both S1 and S3 are generated, downward trace 104 is defined.

If both S1 and S2 are generated, downward trace 104 is defined.

### Example 3

Refer to FIG. 3C, to define a leftward trace 106, one or more conditions S1, S2 and S3 need to be fulfilled:

S1: Generate X1 negative direction tendency 50 on X1 axis 10.

S2: Generate X2 negative direction tendency 54 on X2 axis 12.

S3: Firstly proximity-sensing units of Y2 axis 16 detect to obtain sensing values exceeding a preset threshold, and then proximity-sensing units of Y1 axis 14 detect sensing values exceeding the preset threshold as well. Thus, it is confirmed that the object moves from Y2 axis 16 to Y1 axis 14.

If either condition S1 or S2 or S3 is generated, leftward trace 106 is defined.

If both condition S1 and S2 are generated, leftward trace 106 is defined.

If both condition S1 and S3 are generated, generated, leftward trace 106 is defined.

### Example 4

Refer to FIG. 3D. To define rightward trace 108, one or more conditions S1, S2 and S3 need to be fulfilled:

S1: Generate positive direction tendency 52 on X1 axis 10.

S2: Generate X2 positive direction tendency 56 on X2 axis 12.

S3: Firstly proximity-sensing units on Y1 axis 14 detect to obtain sensing values exceeding a preset threshold, and then proximity-sensing units on Y2 axis 16 detect sensing values exceeding the preset threshold, thus it is confirmed that the object moves from Y1 axis 14 to Y2 axis 16.

If condition S1 or S2 or S3 is generated, rightward trace 108 is detected.

If both condition S1 and S2 are generated, rightward trace 108 is detected.

If both condition S1 and S3 are generated, rightward trace 108 is detected.

### Example 5

Refer to FIG. 3E. To define right downward trace 110, one or more conditions S1, S2, S3 and S4 needs to be fulfilled. In FIG. 3E, condition S1 is the moving condition at the left upper corner of proximity-sensing panel; condition S2 is the moving condition at the right upper corner of proximity-sensing panel; condition S3 is the moving condition at the right lower corner of proximity-sensing panel; and condition S4 is the moving condition at the left lower corner of proximity-sensing panel.

S1: Generate X1 positive direction tendency 52 on X1 axis 10, and on Y1 axis 14, Y1 downward direction tendency 60 is generated.

S2: On X1 axis 10, X1 positive direction tendency 52 is generated; and on Y2 axis 16, Y2 downward direction tendency 64 is generated.

S3: On X2 axis 12, X2 positive direction tendency 56 is generated; and on Y2 axis 16, Y2 downward direction tendency 64 is generated.

S4: On X2 axis 12, X2 positive direction tendency 56 is generated; and on Y1 axis 14, Y1 downward direction tendency 60 is generated.

If any condition S1 or S2 or S3 or S4 is generated, right downward trace 110 is defined.

### Example 6

Please refer to FIG. 3F. To define left downward trace 112, one or more conditions 51, S2, S3 and S4 needs to be fulfilled. In FIG. 3G, condition S1 is the moving condition at the left upper corner of proximity-sensing panel; condition S2 is the moving condition at the right upper corner of proximity-sensing panel; condition S3 is the moving condition at the right lower corner of proximity-sensing panel; condition S4 is the moving condition at the left lower corner of proximity-sensing panel.

S1: On X1 axis 10, X1 negative direction tendency 50 is generated; and Y1 axis 14, Y1 downward direction tendency 60 is generated.

S2: On X1 axis 10, X1 negative direction tendency 50 is generated; and on Y2 axis 16, Y2 downward direction tendency 64 is generated.

S3: On X2 axis 12, X2 negative direction tendency 54 is generated; and on Y2 axis 16, Y2 downward direction tendency 64 is generated.

S4: On X2 axis 12, X2 negative direction tendency 54 is generated and on Y1 axis 14, Y1 downward direction tendency 60 is generated.

If condition S1 or S2 or S3 or S4 is generated, left downward trace 112 is defined.

### Example 7

Please refer to FIG. 3G. To define right upward trace 114, one or more conditions S1, S2, S3 and S4 need to be fulfilled. In FIG. 3G, condition S1 is the moving condition at the left upper corner of proximity-sensing panel; condition S2 is the moving condition at the right upper corner of proximity-sensing panel; condition S3 is the moving condition at the right lower corner of proximity-sensing panel; condition S4 is the moving condition at the left lower corner of proximity-sensing panel.

S1: On X1 axis 10, X1 positive direction tendency 52 is generated; and on Y1 axis 14, Y1 upward direction tendency 58 is generated.

S2: On X1 axis 10, X1 positive direction tendency 52 is generated; and on Y2 axis 16, Y2 upward direction tendency 62 is generated.

S3: On X2 axis 12, X2 positive direction tendency 56 is generated; and on Y2 axis 16, Y2 upward direction tendency 62 is generated.

S4: On X2 axis 12, X2 positive direction tendency 56 is generated; and on Y1 axis 14, Y1 upward direction tendency 58 is generated.

If any condition S1 or S2 or S3 or S4 is generated, right upward trace 114 is defined.

### Example 8

Please refer to FIG. 3H. To define left upward trace 116, one or more conditions S1, S2, S3 and S4 need to be fulfilled. In FIG. 3H, condition S1 is the moving condition at the left upper corner of proximity-sensing panel; condition S2 is the moving condition at the right upper corner of proximity-sensing panel; condition S3 is the moving condition at the right lower corner of proximity-sensing panel; condition S4 is the moving condition at the left lower corner of proximity-sensing panel.

S1: On X1 axis 10, X1 negative direction tendency 50 is generated; and on Y1 axis 14, Y1 upward direction tendency 58 is generated.

S2: On X1 axis 10, X1 negative direction tendency 50 is generated; and on Y2 axis 16 Y2 upward direction tendency 62 is generated.

S3: On X2 axis 12, X2 negative direction tendency 54 is generated; and on Y2 axis 16, Y2 upward direction tendency 62 is generated.

S4: On X2 axis 12, X2 negative direction tendency 54 is generated; and on Y1 axis 14, Y1 upward direction tendency 58 is generated.

If any condition S1 or S2 or S3 or S4 is generated, left upward trace 116 is defined.

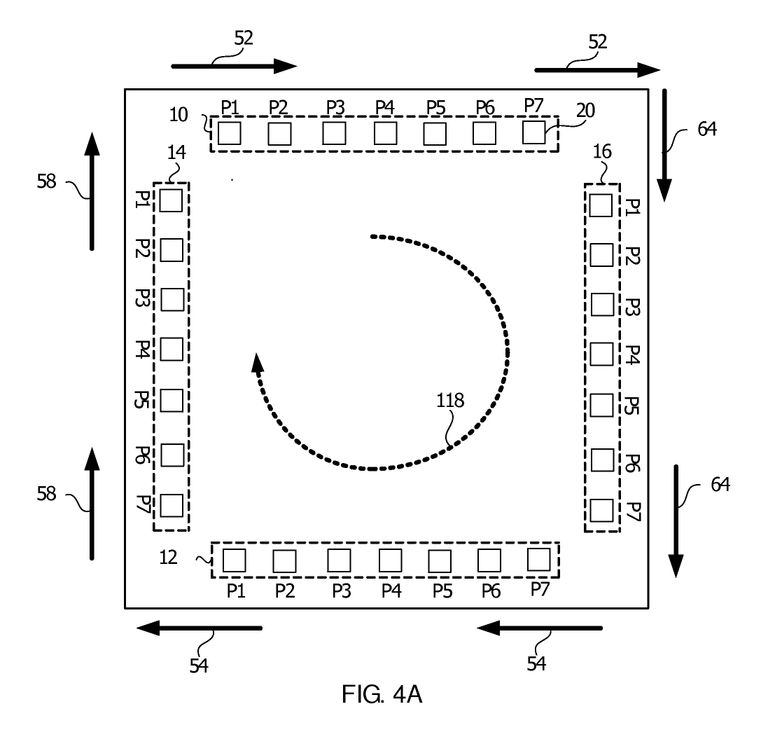

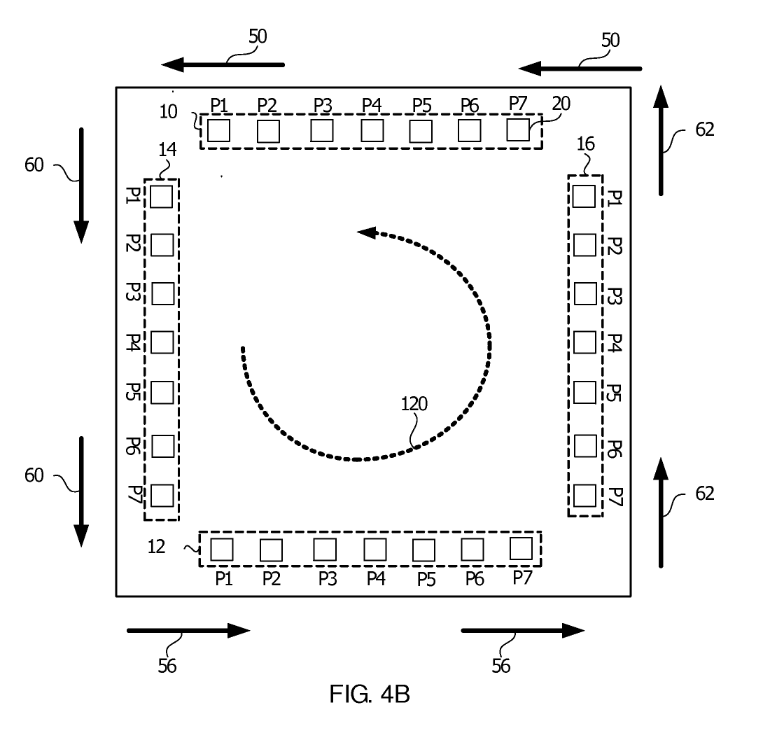

In addition, another common gesture is rotation type, which is also able to be realized through the following embodiments. Please refer to FIG. 4A and FIG. 4B, which are explanatory diagrams of another proximity-sensing panels detecting moving direction tendencies and rotation gestures according to another embodiments.

### Example (1)

Please refer to FIG. 4A. To define clockwise trace 118, one or more conditions S1, S2, S3 and S4 need to be fulfilled.

S1: On X1 axis 10, X1 positive direction tendency 52 is generated; and on Y1 axis 14, Y1 upward direction tendency 58 is generated.

S2: On X1 axis 10, X1 positive direction tendency 52 is generated; and on Y2 axis 16, Y2 downward direction tendency 64 is generated.

S3: On X2 axis 12, X2 negative direction tendency 54 is generated; and on Y2 axis 16, Y2 downward direction tendency 64 is generated.

S4: On X2 axis 12, X2 negative direction tendency 54 is generated; and on Y1 axis 14, Y1 upward direction tendency 58 is generated.

If conditions S1 and S2 and S3 and S4 are generated, clockwise trace 118 is defined.

If conditions S1 and S2 and S3 are generated, clockwise trace 118 is defined.

If conditions S2 and S3 and S4 are generated, clockwise trace 118 is defined.

If conditions S3 and S4 and S1 are generated, clockwise trace 118 is defined.

If conditions S4 and S1 and S2 are generated, clockwise trace 118 is defined.

If conditions S1 and S2 are generated, clockwise trace 118 is defined.

If conditions S2 and S3 are generated, clockwise trace 118 is defined.

If conditions S3 and S4 are generated, clockwise trace 118 is defined.

If conditions S4 and S1 are generated, clockwise trace 118 is defined.

### Example (2)

Please refer to FIG. 4B. To define counterclockwise trace 120, one or more conditions S1, S2, S3 and S4 need to be fulfilled.

S1: On X1 axis 10, X1 negative direction tendency 50 is generated; and on Y1 axis 14, Y1 downward direction tendency 60 is generated.

S2: On X1 axis 10, X1 negative direction tendency 50 is generated; and on Y2 axis 16, Y2 upward direction tendency 62 is generated.

S3: On X2 axis 12, X2 positive direction tendency 56 is generated; and on Y2 axis 16, Y2 upward direction tendency 62 is generated.

S4: On X2 axis 12, X2 positive direction tendency 56 is generated; and on Y1 axis 14, Y1 downward direction tendency 60 is generated.

If conditions 51 and S2 and S3 and S4 are generated, counterclockwise trace 120 is defined.

If conditions S1 and S2 and S3 are generated, counterclockwise trace 120 is defined.

If conditions S1 and S2 and S3 are generated, counterclockwise trace 120 is defined.

If conditions S1 and S2 and S3 are generated, counterclockwise trace 120 is defined.

If conditions S1 and S2 and S3 are generated, counterclockwise trace 120 is defined.

If conditions S1 and S2 are generated, counterclockwise trace 120 is defined.

If conditions S2 and S3 are generated, counterclockwise trace 120 is defined.

If conditions S3 and S4 are generated, counterclockwise trace 120 is defined.

If conditions S4 and S1 are generated, counterclockwise trace 120 is defined.

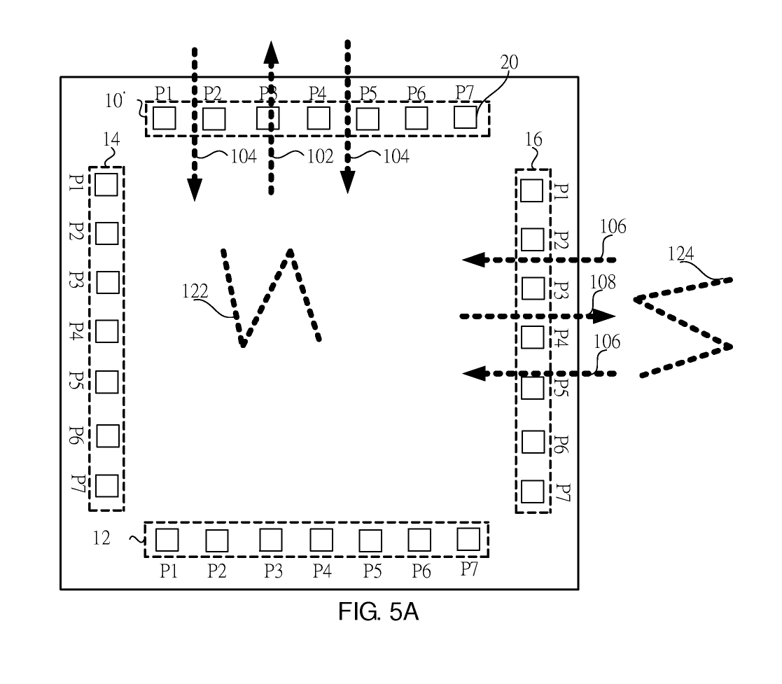

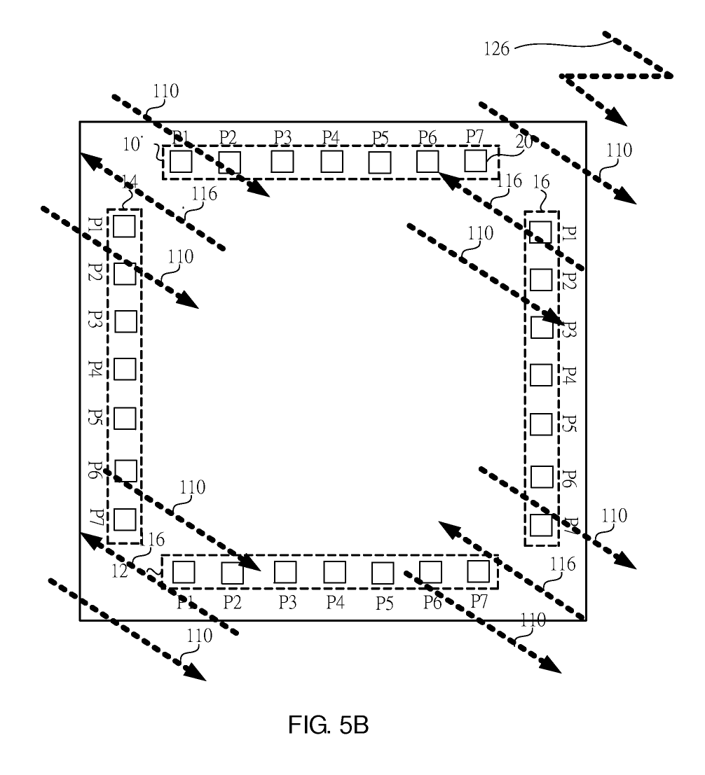

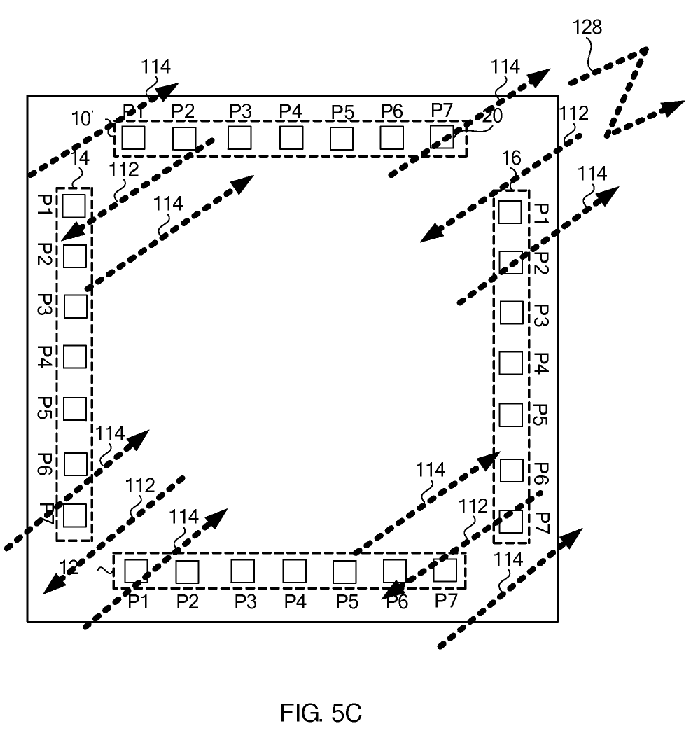

In addition, other types of special gestures are also able to be realized according to the following embodiments. Refer to FIGS. 5A-5C, which are explanatory diagrams of another proximity-sensing panels detecting moving direction tendencies and special gestures according to another embodiments. FIG. 5A shows an up-down back-and-forth trace 122 and left-right back-and-forth trace 124. FIG. 5B shows a left-upper-to-right-lower back-and-forth trace 126. FIG. 5C shows a right-upper-to-left-lower back-and-forth trace 128.

### Example I

Please refer to FIG. 5A; to define up-down back-and-forth trace 122 and left-right back-and-forth trace 124, one or more conditions L1, L2, L3 and L4 need to be fulfilled. Condition L1 is the trace condition on X1 axis 10; and condition L2 is the trace condition on X2 axis 12; condition L3 is the trace condition on Y1 axis 14; and condition L4 is the trace condition on Y2 axis 16.

L1: Generate a trace combination on X1 axis 10, including upward trace 102, downward trace 104 and upward trace 102.

L2: Generate a trace combination on X2 axis 10, including upward trace 102, downward trace 104 and upward trace 102.

L3: Generate a trace combination on Y1 axis 14, including leftward trace 106, rightward trace 108 and leftward trace 106.

L4: Generate a trace combination on Y2 axis 16, including leftward trace 106, rightward trace 108 and leftward trace 106.

If condition L1 or L2 is generated, up-down back-and-forth trace 122 is defined.

If condition L3 or L4 is generated, up-down back-and-forth trace 122 is defined.

### Example II

Refer to FIG. 5B. To define left-upper-to-right-lower back-and-forth trace 126, conditions L1, L2, L3 and L4 need to be fulfilled. In FIG. 5B, condition L1 is the moving condition at the left upper corner of proximity-sensing panel; condition L2 is the moving condition at the right upper corner of proximity-sensing panel; condition L3 is the moving condition at the right lower corner of proximity-sensing panel; condition L4 is the moving condition at the left lower corner of proximity-sensing panel.

L1: Generate a trace combination at left-upper corner of the proximity-sensing panel, including right-downward trace 110, left-upward trace 116 and right-downward trace 110.

L2: Generate a trace combination at right-upper corner of the proximity-sensing panel, including right-downward trace 110, left-upward trace 116 and right-downward trace 110.

L3: Generate a trace combination at left-lower corner of the proximity-sensing panel, including right-downward trace 110, left-upward trace 116 and right-downward trace 110.

L4: Generate a trace combination at right-lower corner of the proximity-sensing panel, including right-downward trace 110, left-upward trace 116 and right-downward trace 110.

If any condition L1 or L2 or L3 or L4 is generated, left-upper-to-right-lower back-and-forth trace 126 is defined.

### Example III

Please refer to FIG. 5C; to define right-upper-to-left-lower trace 128, one or more conditions L1, L2, L3 and L4 need to be fulfilled. In FIG. 5C, condition L1 is the moving condition at the left upper corner of proximity-sensing panel; condition L2 is the moving condition at the right upper corner of proximity-sensing panel; condition L3 is the moving condition at the right lower corner of proximity-sensing panel; condition L4 is the moving condition at the left lower corner of proximity-sensing panel.

L1: Generate a trace combination at left-upper corner of the proximity-sensing panel, including right-upward trace 110, left-downward trace 116 and right-upward trace 110.

L2: Generate a trace combination at right-upper corner of the proximity-sensing panel, including right-upward trace 110, left-downward trace 116 and right-upward trace 110.

L3: Generate a trace combination at left-lower corner of the proximity-sensing panel, including right-upward trace 110, left-downward trace 116 and right-upward trace 110.

L4: Generate a trace combination at left-lower corner of the proximity-sensing panel, including right-upward trace 110, left-downward trace 116 and right-upward trace 110.

If either L1 or L2 or L3 or L4 is generated, right-upper-to-left-lower trace 128 is defined.

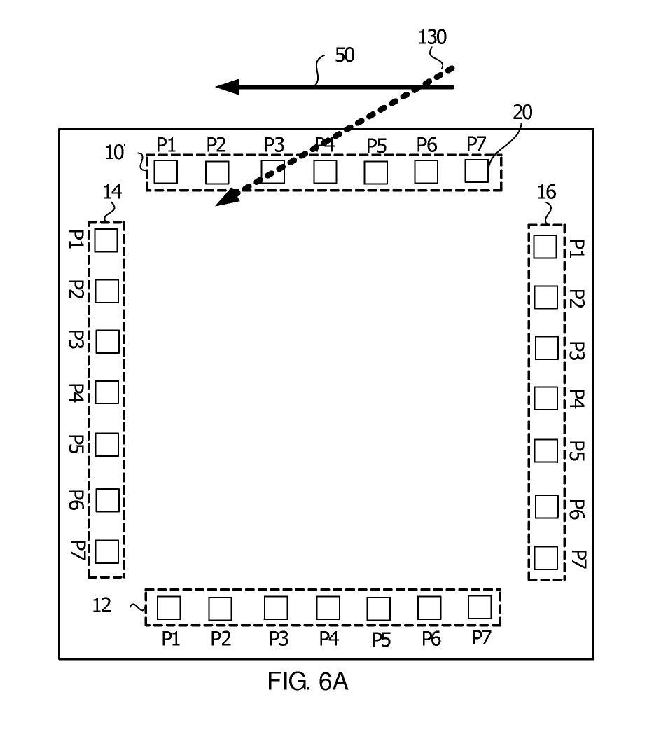

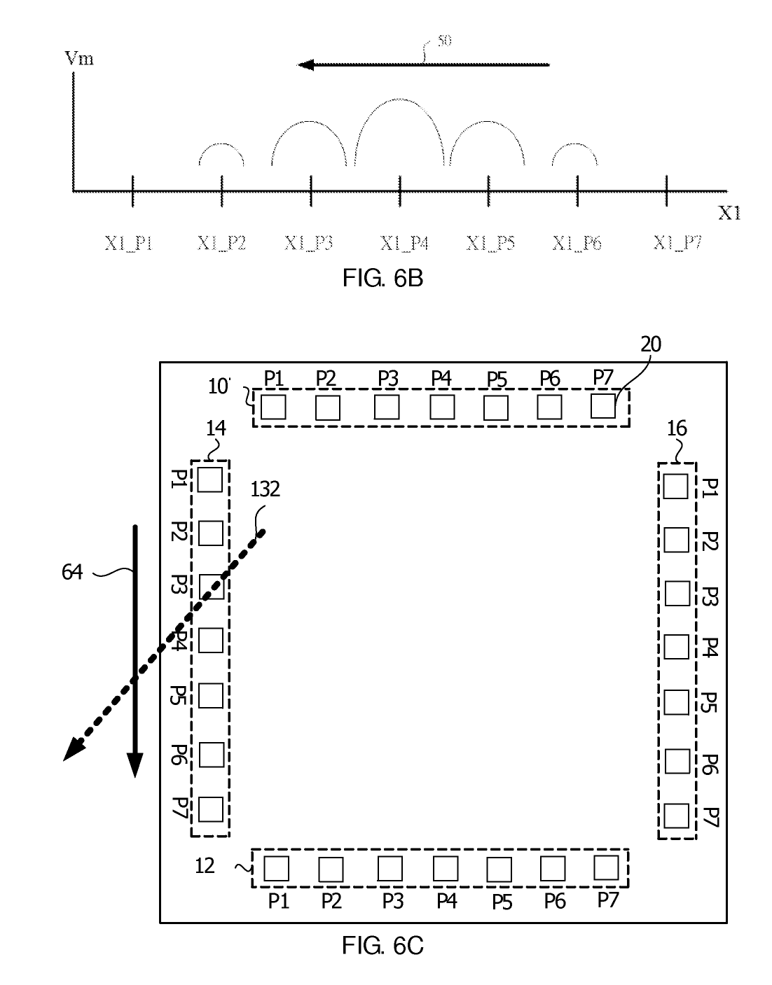

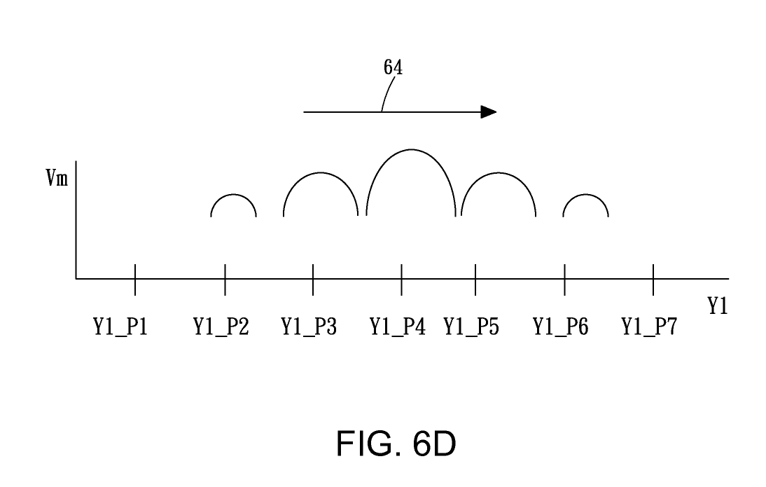

In addition, there are some other gestures able to be realized through the following embodiments. Each of FIGS. 6A and 6C is an explanatory diagram of another proximity-sensing panel with moving direction tendencies and another gesture according to another embodiment. FIG. 6A shows a horizontal left-downward trace 130; and FIG. 6C shows a vertical left-downward trace 132.

### Example (i)

Refer to FIG. 6A, in which an object (not shown) moves relative to X1 axis 10 with a horizontal left-downward trace 130. When an object moves horizontally and left-downwards, X1 negative direction tendency 50 and certain sensing values are generated on X1 axis 10, in which the sensing points with proximity-sensing units on X1 axis 10 are X1_P6, X1_P5, X1_P4, X1_P3 and X1_P2, with the sensing values and moving tendency detected as shown in FIG. 6B. The sensing value is small at X1_P6 and changes into the great sensing value at X1_P4; then changes again from the great sensing value at X1_P4 to the small sensing value at X1_P2; in which the moving tendency is generated as X1 negative direction tendency 50. Therefore, to determine the movement of an object along horizontal left-downward trace 130, the moving tendency and the sensing values are able to be used as a basis.

### Example (ii)

Refer to FIG. 6C, in which an object (not shown) moves from Y1 axis 14 along a vertical left-downward trace 132. When an object moves leftward and downward, Y1 downward direction tendency 64 and sensing values are generated on Y1 axis 14, in which the proximity-sensing units detect at points of Y1_P2, Y1_P3, Y1_P4, Y1_P5 and Y1_P6, with detected sensing values and moving tendency shown in FIG. 6D. The sensing values changes from the small sensing value at Y1_P2 to the great sensing value at Y1_P4; and then changes from the great sensing value at Y1_P4 to the small value at Y1_P6; in which the moving tendency is defined as Y1 downward direction tendency 64. Therefore, to determine the movement of an object along a vertical left-downward trace 132, the generated moving tendency and the detected sensing values are able to be used as a basis.

The traces disclosed in the above FIGS. 3A-3G, FIGS. 4A-4B, FIGS. 5A-5C, FIGS. 6A and 6C, are partial examples for the moving traces and gestures realizable by the embodiments. There are certain gestures corresponding to certain traces, such as: a Drag Up gesture corresponding to a upward trace, a Drag Down gesture corresponding to a downward trace, a Forward gesture corresponding to a leftward trace, a Back gesture corresponding to a rightward trace, a Delete gesture corresponding to a left upward trace, a Undo gesture corresponding to a left downward trace, a Copy gesture corresponding to a right upward trace, a Paste gesture corresponding to a right downward trace, a Redo gesture corresponding to a counterclockwise trace, a Undo gesture corresponding to a clockwise trace, a self-defined gesture corresponding to a up-down back-and-forth trace, another self-defined gesture corresponding to a left-right back-and-forth trace, another self-defined gesture corresponding to a left-upper-to-right-lower back-and-forth trace, another self-defined gesture corresponding to a right-upper-to-left-lower back-and-forth trace, another self-defined gesture corresponding to a horizontal left-downward trace, and another self-defined gesture corresponding to a vertical left-downward trace. Any other gesture is able to be defined according what disclosed in the embodiments; the disclosed sensing axes are able to detect and determine the object's moving traces, and any possible gesture as well.

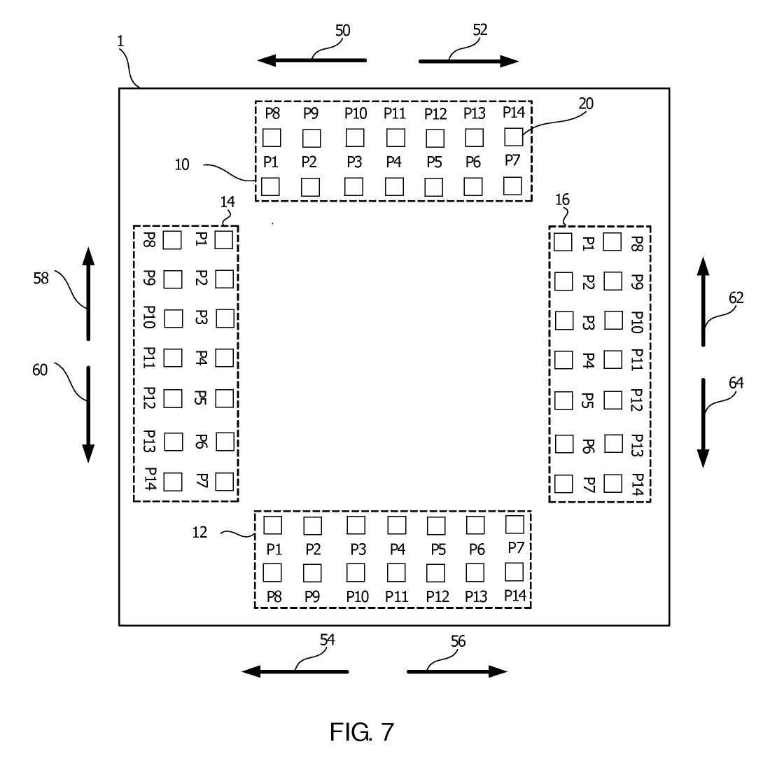

Refer to FIG. 7, which is an explanatory diagram of another proximity-sensing panel with sensing axes and moving direction tendencies according to another embodiment. In FIG. 7, four axes X1 axis 10, X2 axis 12, Y1 axis 14 and Y2 axis 16 are defined. Each of the sensing axes includes 14 proximity-sensing units 20. On X1 axis 10, the proximity-sensing units 20 detect to define X1 positive direction tendency 52 and X1 negative direction tendency 50. On X2 axis 12, the proximity-sensing units 20 detect to define X2 positive direction tendency 56 and X2 negative direction tendency 54. On Y1 axis 14, the proximity-sensing units 20 detect to define Y1 positive direction tendency 52 and Y1 negative direction tendency 50. On Y2 axis 16, the proximity-sensing units 20 detect to define Y2 positive direction tendency 52 and Y2 negative direction tendency 50. In different embodiments, at each sides of the proximity-sensing panel, more than one sensing axes are able to be defined; on each sensing axis, more than one rows of proximity-sensing units 20 are able to be defined.

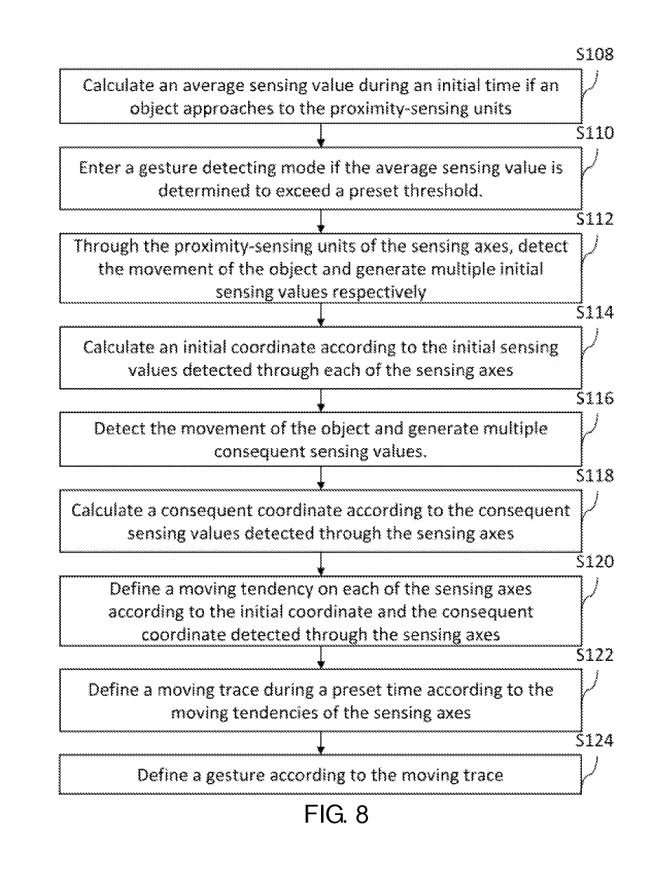

Refer to FIG. 8, which is a flow chart of a gesture detecting method applied on a proximity-sensing panel. The method includes the following portions:

Step S108: Calculate an average sensing value during an initial time if an object approaches to the proximity-sensing units.

Step S110: Enter a gesture detecting mode if the average sensing value is determined to exceed a preset threshold.

Step S112: Through the proximity-sensing units of the sensing axes, detect the movement of the object and generate multiple initial sensing values respectively.

Step S114: Calculate an initial coordinate according to the initial sensing values detected through each of the sensing axes.

Step S116: Detect the movement of the object and generate multiple sequent sensing values.

Step S118: Calculate a sequent coordinate according to the sequent sensing values detected through the sensing axes.

Step S120: Define a moving tendency on each of the sensing axes according to the initial coordinate and the sequent coordinate detected through the sensing axes.

Step S122: Define a moving trace during a preset time according to the moving tendencies of the sensing axes.

Step S124: Define a gesture according to the moving trace.

Furthermore, in Step S122, The moving trace is defined during a preset time according to the moving tendencies of the sensing axes. the preset time is set as 0.1-3 seconds.

The portion of defining the gesture according to the moving trace further includes the following procedures. Compare the moving traces with multiple preset moving traces stored in a database to define the gesture. The method of comparing the moving traces and the preset moving traces uses fuzzy comparison or trend analysis comparison.

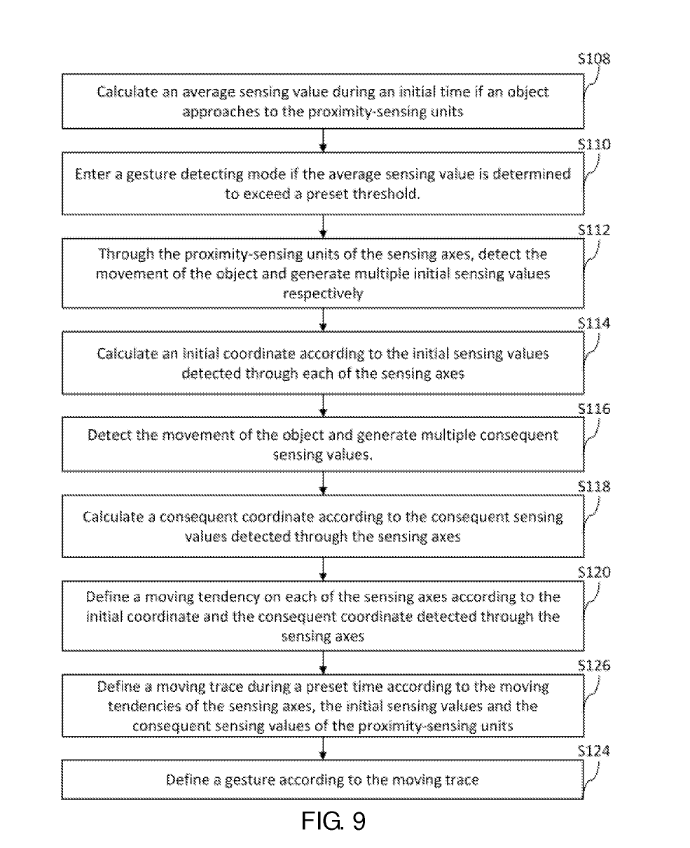

Refer to FIG. 9, which is a flow chart of a gesture detecting method applied on a proximity-sensing panel according to another embodiment. The method includes the following portions.

Step S108: Calculate an average sensing value during an initial time if an object approaches to the proximity-sensing units.

Step S110: Enter a gesture detecting mode if the average sensing value is determined to exceed a preset threshold.

Step S112: Through the proximity-sensing units of the sensing axes, detect the movement of the object and generate multiple initial sensing values respectively.

Step S114: Calculate an initial coordinate according to the initial sensing values detected through each of the sensing axes.

Step S116: Detect the movement of the object and generate multiple sequent sensing values.

Step S118: Calculate a sequent coordinate according to the sequent sensing values detected through the sensing axes.

Step S120: Define a moving tendency on each of the sensing axes according to the initial coordinate and the sequent coordinate detected through the sensing axes.

Step S126: Define a moving trace during a preset time according to the moving tendencies of the sensing axes, the initial sensing values and the sequent sensing values of the proximity-sensing units.

Step S124: Define a gesture according to the moving trace.

The difference between FIG. 8 and FIG. 9 is at Step S122 and Step S126. In FIG. 8, Step S122 defines the moving trace according to the moving tendency of the sensing axes; in FIG. 9, Step S126 defines a moving trace during a preset time according to the moving tendencies of the sensing axes, the initial sensing values and the sequent sensing values of the proximity-sensing units. And in the end, the moving trace is used to define a gesture.

While the disclosure has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A gesture detecting method applied to a proximity-sensing panel with a plurality of sensing axes disposed at a perimeter of the proximity-sensing panel, each of the sensing axes having a plurality of proximity-sensing units, the method comprising:
through each of the proximity-sensing units of the sensing axes, detecting the movement of at least an object and generating a plurality of initial sensing values respectively;
calculating at least an initial coordinate according to the initial sensing values detected through each of the sensing axes;
detecting the movement of the object and generating a plurality of sequent sensing values;
calculating at least a sequent coordinate according to the sequent sensing values detected through the sensing axes;
defining at least a moving tendency on each of the sensing axes according to the initial coordinate and the sequent coordinate detected through the sensing axes; and
defining a gesture during a preset time according to the moving tendencies of the sensing axes.

2. The gesture detecting method according to claim 1, wherein the preset time is set as 0.1˜3 seconds.

3. The gesture detecting method according to claim 1, wherein the moving tendencies detected through the sensing axes horizontally disposed at the perimeter of the proximity-sensing panel are selected from the group consisting of a positive direction tendency moving rightwards corresponding to the object, a negative direction tendency moving leftwards corresponding to the object, and any combination thereof.

4. The gesture detecting method according to claim 1, wherein the moving tendencies detected through the sensing axes vertically disposed at the perimeter of the proximity-sensing panel are selected from the group consisting of a upward direction tendency moving upwards corresponding to the object, a downward direction tendency moving downwards corresponding to the object, and any combination thereof.

5. The gesture detecting method according to claim 1 further comprising:
calculating at least an average sensing value during an initial time if the object approaches to the proximity-sensing units; and
entering a gesture detecting mode if the average sensing value is determined to exceed a preset threshold.

6. The gesture detecting method according to claim 5, wherein the initial time is set as 0.1˜5 seconds.

7. The gesture detecting method according to claim 1 further comprising:
generating at least a moving trace according to the moving tendencies of the sensing axes; and
defining the gesture according to the moving trace.

8. The gesture detecting method according to claim 7, wherein the gesture is selected from the group consisting of a Drag Up gesture corresponding to a upward trace, a Drag Down gesture corresponding to a downward trace, a Forward gesture corresponding to a leftward trace, a Back gesture corresponding to a rightward trace, a Delete gesture corresponding to a left upward trace, a Undo gesture corresponding to a left downward trace, a Copy gesture corresponding to a right upward trace, a Paste gesture corresponding to a right downward trace, a Redo gesture corresponding to a counterclockwise trace, a Undo gesture corresponding to a clockwise trace, a self-defined gesture corresponding to a up-down back-and-forth trace, another self-defined gesture corresponding to a left-right back-and-forth trace, another self-defined gesture corresponding to a left-upper-to-right-lower back-and-forth trace, another self-defined gesture corresponding to a right-upper-to-left-lower back-and-forth trace, another self-defined gesture corresponding to a horizontal left-downward trace, and another self-defined gesture corresponding to a vertical left-downward trace.

9. The gesture detecting method according to claim 1, wherein the moving tendencies are selected from the group consisting of a horizontal moving tendency, a vertical moving tendency and any combination thereof.

10. A gesture detecting method applied to a proximity-sensing panel with a plurality of sensing axes disposed at a perimeter of the proximity-sensing panel, each of the sensing axes having a plurality of proximity-sensing units, the method comprising:
through each of the proximity-sensing units of the sensing axes, detecting the movement of at least an object and generating a plurality of initial sensing values respectively;
calculating at least an initial coordinate according to the initial sensing values detected through each of the sensing axes;
detecting the movement of the object and generating a plurality of sequent sensing values;
calculating at least a sequent coordinate according to the sequent sensing values detected through the sensing axes;
defining at least a moving tendency on each of the sensing axes according to the initial coordinate and the sequent coordinate detected through the sensing axes; and
defining a gesture during a preset time according to the moving tendencies of the sensing axes, the initial sensing values and the sequent sensing values of the proximity-sensing units.

11. The gesture detecting method according to claim 10, wherein the preset time is set as 0.1˜3 seconds.

12. The gesture detecting method according to claim 10, wherein the moving tendencies detected through the sensing axes horizontally disposed at the perimeter of the proximity-sensing panel are selected from the group consisting of a positive direction tendency moving rightwards corresponding to the object, a negative direction tendency moving leftwards corresponding to the object, and any combination thereof.

13. The gesture detecting method according to claim 10, wherein the moving tendencies detected through the sensing axes vertically disposed at the perimeter of the proximity-sensing panel are selected from the group consisting of a upward direction tendency moving upwards corresponding to the object, a downward direction tendency moving downwards corresponding to the object, and any combination thereof.

14. The gesture detecting method according to claim 10 further comprising:
calculating at least an average sensing value during an initial time if the object approaches to the proximity-sensing units; and
entering a gesture detecting mode if the average sensing value is determined to exceed a preset threshold.

15. The gesture detecting method according to claim 14, wherein the initial time is set as 0.1˜5 seconds.

16. The gesture detecting method according to claim 10 further comprising:
generating at least a moving trace according to the moving tendencies of the sensing axes; and
defining the gesture according to the moving trace.

17. The gesture detecting method according to claim 16, wherein the gesture is selected from the group consisting of a Drag Up gesture corresponding to a upward trace, a Drag Down gesture corresponding to a downward trace, a Forward gesture corresponding to a leftward trace, a Back gesture corresponding to a rightward trace, a Delete gesture corresponding to a left upward trace, a Undo gesture corresponding to a left downward trace, a Copy gesture corresponding to a right upward trace, a Paste gesture corresponding to a right downward trace, a Redo gesture corresponding to a counterclockwise trace, a Undo gesture corresponding to a clockwise trace, a self-defined gesture corresponding to a up-down back-and-forth trace, another self-defined gesture corresponding to a left-right back-and-forth trace, another self-defined gesture corresponding to a left-upper-to-right-lower back-and-forth trace, another self-defined gesture corresponding to a right-upper-to-left-lower back-and-forth trace, another self-defined gesture corresponding to a horizontal left-downward trace, and another self-defined gesture corresponding to a vertical left-downward trace.

18. The gesture detecting method according to claim 10, wherein the moving tendencies are selected from the group consisting of a horizontal moving tendency, a vertical moving tendency and any combination thereof.
